(19) United States
(12) Patent Application Publication
(10) Pub. No.: US 2002/0108811 A1
(43) Pub. Date: Aug. 15, 2002

(54) Ladder stabilization apparatus

(76) Inventors: Robert L. Ulmschneider, Hayes, VA (US); Phillip A. Lee, Hayes, VA (US)

Correspondence Address: GEORGE F. HELFRICH, 162 SHASTA DRIVE, NEWPORT NEWS, VA, 23608, US

(21) Appl. No.: 10/054,792

(22) Filed: Jan. 25, 2002

Related U.S. Application Data
(60) Provisional application No. 60/267,696, filed on Feb. 12, 2001.

(51) Int. Cl. E06C 1/36

(52) U.S. Cl. 182/206

(57) ABSTRACT

A ladder stabilization apparatus attaches to a ladder to provide safety and stability for the ladder's user when the ladder is supported by a tree, a post, a pole, or other non-flat surface. The stabilization apparatus attaches rigidly to the ladder and uses a concavely shaped device with a knife edge, multiple teeth, or rubber gasket to grip the tree, post, or pole, thereby securing the top of the ladder to the non-flat surface. When not in use, the concavely shaped gripper plate can be removed and attached to the ladder in a flat storage position, allowing the ladder to be used against typical flat surfaces.

This application claims the benefit of U.S. Provisional Application No. 60/267,696, which was filed Feb. 12, 2001, and was entitled “Ladder Stabilization Apparatus.”

### BACKGROUND OF THE INVENTION

1. Field of the Invention

The subject invention relates to ladder accessory hardware. The invention relates more specifically to a safety device for securing a ladder against a tree or a pole.

2. Description of the Related Art

Ladders are often used to access utility lines, street lights, electrical transformers, tree limbs, and other things high above the ground, which requires the user to brace the ladder against a tree, post, pole, or other form of circular or non-flat support. When a rung of the ladder makes contact with a non-flat means of support, the support (e.g. tree or pole) effectively causes single point contact, about which the ladder tends to rock, creating an unstable and unsafe situation for the person climbing and using the ladder.

A number of safety devices have been developed to improve the stability of a ladder propped up against a tree, a post, or a pole, however most have proven to be unsatisfactory for one reason or another. Some such devices tend to be inconsistent in the degree to which they provide stability, unnecessarily inconvenient to operate or overly complicated in design, or even unsafe. Those devices which prove to be unsafe are doubly dangerous, as they provide the user with a false sense of security.

One example is described in U.S. Pat. No. 4,469,195. The patented invention utilizes a caliper gripping mechanism with a pulley and line system. The pulley and line system opens the calipers, enabling them to fit about a tree. The tension of a spring is the only force used to drive the calipers into the tree. The spring, stretched widely and repeatedly to accommodate a variety of tree diameters, may lose some of its resiliency and elasticity. In addition, due to its mechanical spring constant, the spring's gripping force is considerably less for a small diameter tree than it is for a large diameter. When propped against a tree of small diameter, a ladder tends to be even less stable than when propped against a large diameter tree; the spring powered device would therefore provide less gripping force when greater-than-normal force would be required. Furthermore, the design provides no mechanism to ensure that the grip will not loosen as the user ascends the ladder. Overall, the invention provides a means for gripping the tree, but its design is far too complex, with many moving parts such as hinges, springs, pulleys, chains, and cords. The high level of complexity introduces an unnecessary number of sources of possible failure, loosening, wear, and other factors not conducive to safety.

In U.S. Pat. No. 4,363,378, the ladder's top-most rung is curved to approximate the curvature of a tree or pole. The operator must climb to the top of the ladder to secure a metal band about the pole. The drawback to this design is that the curved rung does not prevent the ladder from rotating or sliding about the pole while the operator climbs the ladder. The invention does not become operable until the ladder user has already fully climbed to the top of the ladder to secure it with the metal band. Also, the ladder's top rung conforms to only one specific curvature, and has no gripping means for augmenting the level of safety provided. The loosely fitting metal band ensures that the ladder will not fall completely away from a pole or tree, but sudden slippage of the top end of the ladder (either vertically or horizontally) which could spill the ladder's user are not effectively prevented. In short, the moving parts which must be engaged from the top of the ladder, the lack of a gripping means, and the looseness of the strap afford less than satisfactory assurance of safety.

In U.S. Pat. No. 4,946,004, pivotally mounted caliper arms are forced to enclose a tree as the ladder is rested against the tree. No locking mechanism exists to secure the caliper arms about the tree. Also, although the patent uses the term “gripping arms,” no gripping means are provided within the meaning of the term in the present specification, i.e. there are no teeth, knife edges, rubber boots, or the like to enforceably or frictionally engage the caliper arms with the tree or post. The caliper arms merely conform to the shape of the surrounded pole. Not only are they free to slide vertically, but a gust of wind or a misplacement of weight by the operator can also cause the arms to release as a result of the sideward force. In effect, the invention can lose its function at an instant when its performance is most critical. With its combination of pivotably moving parts, its lack of effective gripping means, and its lack of a locking mechanism, the invention provides too many sources of potential accident for its user.

U.S. Pat. No. 5,638,916 describes a bracket that attaches to a ladder and partially grips a tree when the ladder is leaned against the tree. After the ladder user has climbed the ladder, he operates a pair of rotating spikes, which complete the functional engagement with the tree. Once again, the device is fully functional only after the user has initially climbed the ladder and completed the mechanical operation. At least one opportunity for an accident therefore occurs each time the device is used. Although a means for gripping the tree is provided, the necessity for negotiating a number of moving parts from the top of the ladder introduces undesirable safety risks.

In spite of the various attempts to provide a device which safely secures a ladder to a tree, post, or pole, such a device is still not available. As the related art above indicates, numerous inventors over at least the last twenty years (U.S. Pat. No. 4,363,378 was filed in 1980) have been unsuccessful in providing a suitably effective and commercially available ladder safety device for these applications. As a result, it remains perilous to repair utility lines, trim tree branches, service street lights, or perform many other operations which often require leaning a ladder against a non-flat surface. Until an adequate ladder stabilization apparatus becomes available, such operations will continue to put ladder users in danger of serious injury. The present invention therefore satisfies a long-felt need for electricians, power linemen, cable television technicians, tree trimmers, and others, whose jobs would be made safer by the availability of such a device.

### BRIEF SUMMARY OF THE INVENTION

Accordingly, it is an object of the present invention to provide a ladder stabilization apparatus which is relatively simple and can be used with most typical ladders.

It is another object of the present invention to provide an apparatus which effectively grips a tree, post, pole, or other non-flat object against which it is placed.

It is a further object of the present invention to provide a ladder safety device which tends to produce a greater gripping action as weight is applied to the ladder by its user.

It is yet another object of the present invention to provide a ladder safety device which is functionally and effectively engaged as soon as it is in contact with a tree, post, or pole.

It is another object of the present invention to provide a ladder safety device with no moving parts, thereby minimizing possible modes of failure or malfunction.

It is a further object of the present invention to provide a ladder safety device which can be conveniently removed from its operational assembly position and placed in a storage position, allowing the ladder to be used without the safety device if so desired.

The present invention is a ladder stabilization apparatus which accomplishes the objects above. These and other objects will become more readily appreciated and understood from a consideration of the following detailed description of the exemplary embodiment, when taken together with the accompanying drawings.

The preferred embodiment of the present invention attaches to a ladder to provide safety and stability for the ladder's user when the ladder is supported by a tree, a post, a pole, or other non-flat surface. The stabilization apparatus attaches rigidly to the ladder, using a mounting plate and U-bolts.

A gripper plate with an outwardly extending, concavely shaped section attaches to the mounting plate using shear pins and threaded knobs. The concave geometry of the gripper plate may be substantially V-shaped, or it may be substantially circular, elliptical, parabolic, or otherwise, as long as it is configured to enclose and to help grip a tree, post, or pole with which it makes contact. The concave section of the gripper plate is equipped with a knife edge, multiple teeth, or rubber friction-producing boot (i.e. gasket) to grip the tree, post, or pole, thereby securing the top of the ladder to the non-flat surface.

When not in use, the concavely shaped gripper plate can be removed conveniently and stored. The apparatus is further equipped with an angle block, attached to the mounting plate. The angle block is beveled to approximate the angle between the upper surfaces of the ladder steps and the ladder legs, thereby allowing the removed gripper plate to be attached to the ladder in a flat storage position. With the gripper plate stored in this position, the ladder can be used against typical flat surfaces without removing the entire fixture or storing any of its components elsewhere. The present invention is therefore an apparatus which allows a ladder to be securely supported by a tree or pole, but can also be stored conveniently when not required.

### BRIEF DESCRIPTION OF THE SEVERAL VIEWS OF THE DRAWINGS

FIG. 1 is an exploded view of an assembly of one embodiment of the subject invention, a ladder stabilization apparatus.

FIG. 2 is a planform depiction of one embodiment of a gripper plate component of the subject invention.

FIG. 3A is a planform view of one embodiment of a rubber boot, for use in conjunction with a gripper plate.

FIG. 3B is a cross-sectional view of the embodiment of a rubber boot depicted in FIG. 3A, shown in assembly over the teeth of a gripper plate.

FIG. 4A is a planform illustration of one embodiment of a mounting plate for a ladder stabilization apparatus.

FIG. 4B is a planform depiction of one embodiment of a mounting plate minus the optional flanges otherwise made to engage a pair of ladder legs.

FIG. 5A is a perspective view of one embodiment of a beveled angle block.

FIG. 5B is a cross-sectional view of the beveled angle block depicted in FIG. 5A.

FIG. 5C is a side view depiction of one embodiment of an assembly of the subject invention in storage position, with the gripper plate stored on the upper (user) side of the ladder.

FIG. 5D is a side view depiction of another embodiment of an assembly of the subject invention in a storage position, with the gripper plate stored on the lower (pole or tree) side of the ladder.

FIG. 6 is a perspective view of one embodiment of a U-bolt clamp.

FIG. 7A is a planform depiction of one embodiment of the subject invention, assembled and used for securing a ladder against a tree.

FIG. 7B is a planform depiction of one embodiment of the subject invention, assembled and used for securing a ladder against a wooden pole.

FIG. 7C is a planform depiction of one embodiment of the subject invention, assembled and used for securing a ladder against a metal pole.

### DETAILED DESCRIPTION OF THE INVENTION

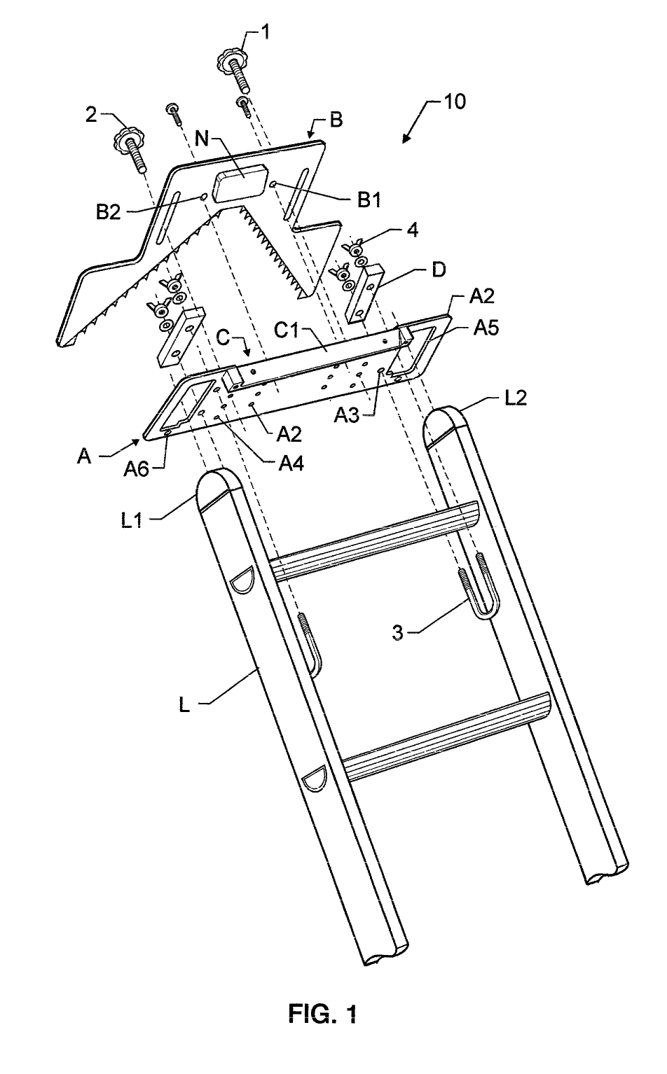

One embodiment of the present invention is depicted in FIGS. 1 through 7C and is generally denoted by reference number 10. The depicted embodiment represents the best mode, known at present, for practicing the invention. A variety of other embodiments could certainly be imagined by one skilled in the art, using the same general design and achieving similar objectives.

FIG. 1 is an exploded assembly, showing examples of components of one embodiment of the present invention. Gripper plate B makes contact with a tree, pole, or other object against which a ladder L is to be positioned. Mounting plate A can be used to secure gripper plate B to the ladder L, although some embodiments of the invention comprise a gripper plate or similar gripper device attached directly to the ladder.

In one embodiment of the invention, angle block C attaches either to the mounting plate or directly to the ladder L. Angle block C or a similar device enables the attachment of gripper plate B essentially in a flat position against the ladder, providing a convenient means for storing gripper plate B, and allowing mounting plate A or other mounting hardware to remain attached to the ladder for later use. In the illustrated embodiment of the present invention, fasteners can be used to rigidly attach angle block C to mounting plate A, although angle block C might also be permanently attached to mounting plate A by welding, or could be part of mounting plate A itself, fabricated as one piece.

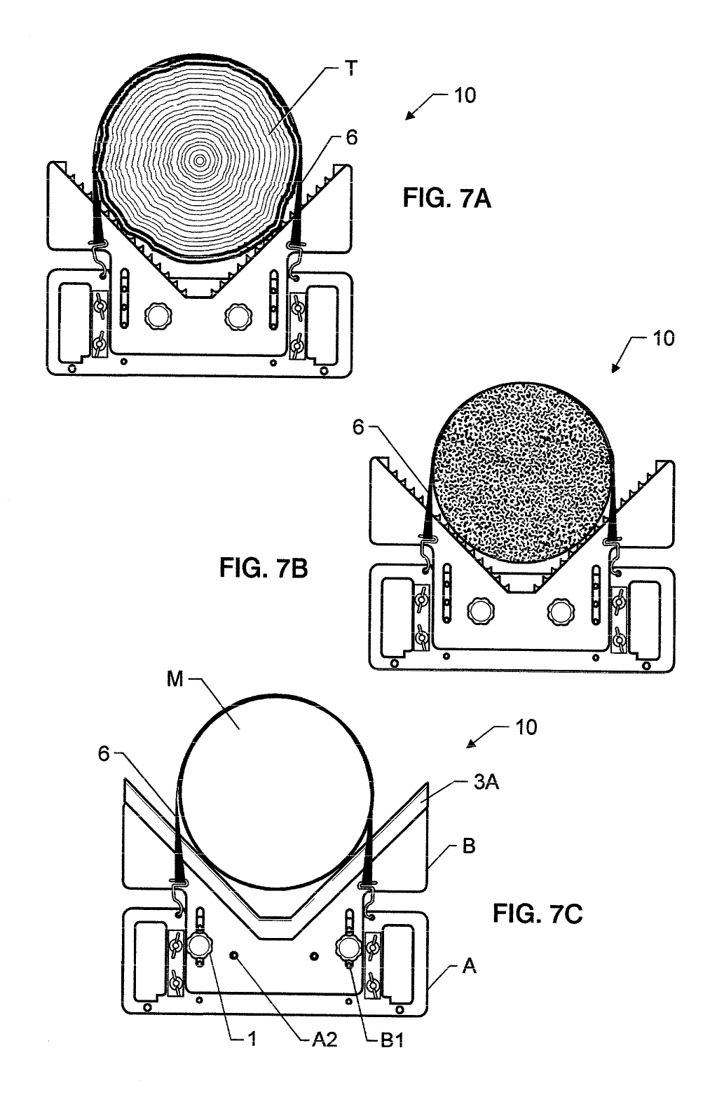

A set of U-bolts 3 and associated wing nuts 4 are used in one embodiment of the present invention to secure mounting plate A to the ladder, and a corresponding set of U-bolt clamps D provide a firm, stable surface against which a set of wing nuts or other fastening hardware can provide secure attachment. In the depicted embodiment, a pair of threaded knobs 1 secure gripper plate B to mounting hardware, for example to mounting plate A as illustrated. A set of shear pins 2, dowels, or similar hardware can be used to fix the position of gripper hardware in relation to mounting hardware, to prevent slippage, and to resist forces applied to the ladder or applied to the gripper in a direction essentially perpendicular to the pins. The pair of threaded knobs 1 provides a means to secure a gripper device to mounting hardware, for example by pulling gripper plate B down snug against mounting plate A. An additional safety device, such as strap 6 (see FIGS. 7A, 7B, and 7C), or a cord, or a cable, can be attached to the ladder or to other components of the present invention and secured to the tree or pole to provide redundant means for stabilization.

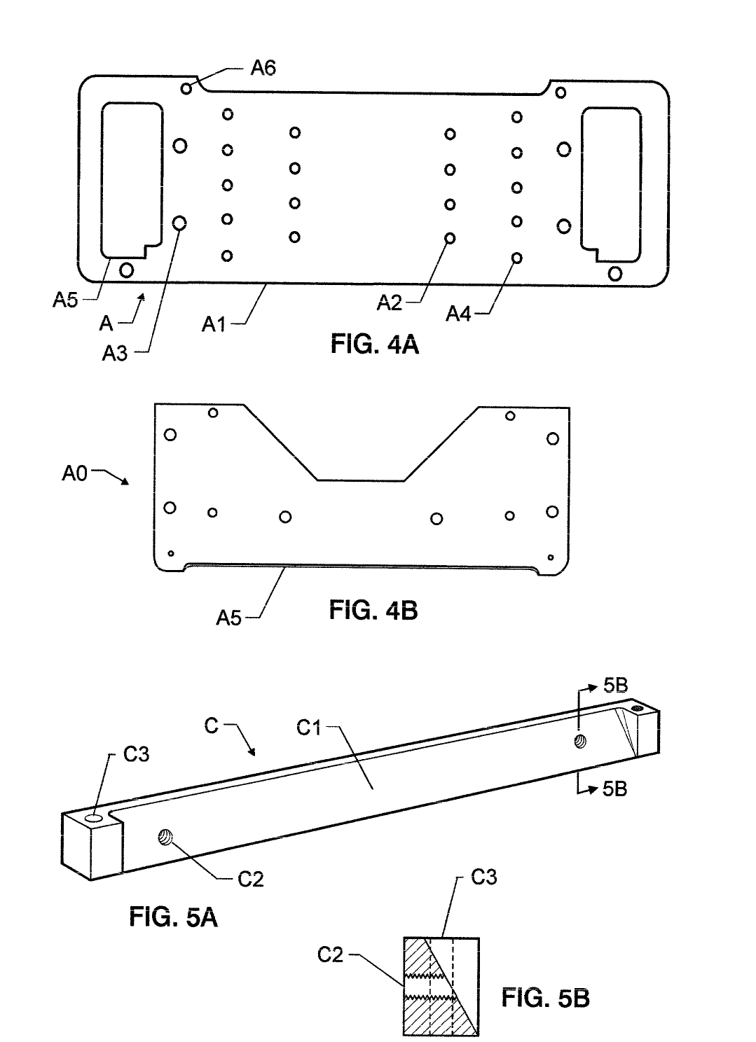

In the embodiment of the present invention depicted in FIG. 1, mounting plate A is rigidly attached to the uppermost step S of a ladder L by a set of U-bolts 3, passing through mounting plate A and U-bolt clamps D, and secured by wing nuts 4. Mounting plate A has an optional pair of flanges A₁, one at each end, which slip over the legs (L₁ and L₂) of the ladder L for added security. An embodiment without optional flanges A₁, is illustrated in FIG. 4B. Conversely, an embodiment is also envisioned (not shown) in which flanges A₁ allow clamped attachment solely to the legs (L₁ and L₂) of the ladder L, fastened securely enough so that U-bolts 3 and other hardware are not required. Such an embodiment would make attachment to a rung of the ladder unnecessary.

Referring back to FIG. 1, Gripper plate B is rigidly attached to mounting plate A, using shear pins 2 which pass through aligned holes B₂ and A₂ in gripper plate B and mounting plate A, respectively. Gripper plate B is further secured by threaded knobs 1, which pass through optional slots B₁, in gripper plate B, providing adjustable (fore and aft) positioning of gripper plate B, and then mate with aligned, threaded holes A₄ in mounting plate A. Threaded knobs 1 consist of threaded fasteners equipped with knobs which allow them to be tightened and loosened for assembly and disassembly by hand.

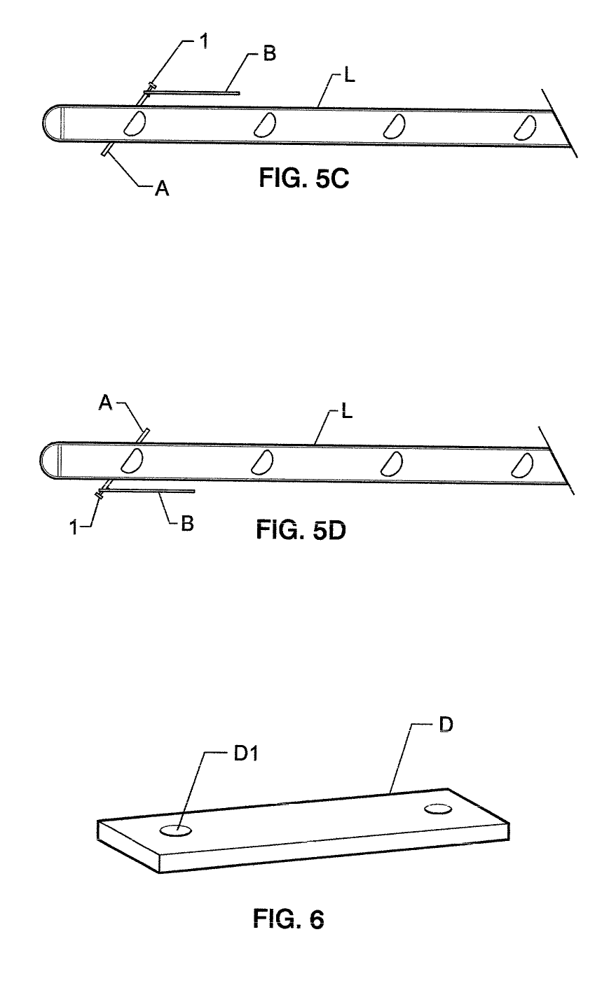

Angle block C rigidly attaches to mounting plate A by bolting or other mechanical attachment technique, and provides a surface C₁ parallel to the length of the ladder. Parallel surface C₁ provided by angle block C is drilled and tapped so that gripper plate B, when removed from mounting plate A, can be rigidly attached to angle block C in a position flat against the ladder, convenient for storage when not in use. In a prescribed storage position (see FIG. 5C), gripper plate B is attached to angle block C using threaded knobs 1, the same threaded knobs 1 otherwise used to attach gripper plate B to mounting plate A when gripper plate B is in its functional position.

Safety strap 6 (See FIGS. 7A, 7B, and 7C) attaches to eyebolts, other attachment hardware, or strap attachment holes A₆ at each end of mounting plate A, and passes around the tree or pole against which the ladder leans, in order to further secure the ladder. Also in the illustrated embodiment of the present invention (see FIGS. 7A-C), string or light cable (not shown) can be attached from one end of each shear pin 2 to small drilled holes in the mounting plate A to prevent shear pins 2 from being dropped when not in functional position. All components of the apparatus depicted in FIG. 1, with the exception of the string or cable and the safety strap, are preferably fabricated from a suitable structural, corrosion-resistant material such as stainless steel, aluminum, composite, or high-strength plastic.

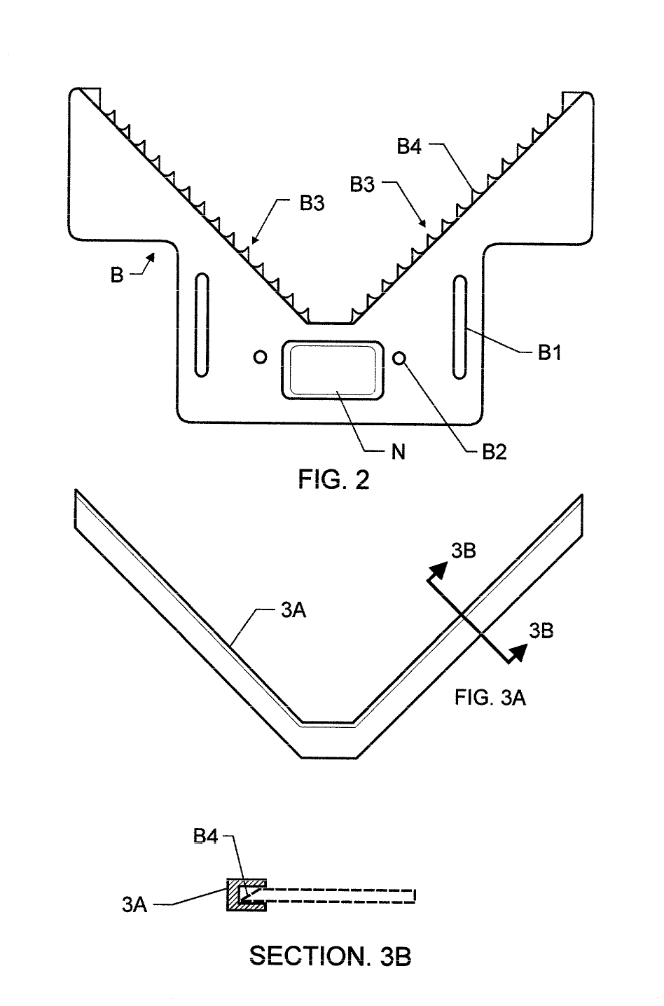

Referring now to FIG. 2, one embodiment of a gripper plate B is depicted. In the depicted embodiment, the gripper plate B is shown as a flat plate of appropriate material with a section (B₃) designed to engage a tree, a post, a pole, or other non-flat object against which a ladder may lean. In the illustrated embodiment of the present invention, a substantially V-shaped cut-out B₃ is designed such that a tree may fit into the V-shaped region, preventing the ladder from moving from its position against the tree. In the depiction, the substantially V-shaped region is lined with either a knife-edge (not shown), which may cut into the surface of a tree, or a plurality of teeth B₄ (as shown), which may bite into (i.e. grip) the surface of a tree.

One practiced in the art will recognize that a variety of geometries might be substituted for the V-shaped cut-out B₃. For example, a substantially circular, elliptical, or parabolic curve might provide an appropriate concave shape to engage and to help grip a non-flat surface securely. Elliptical or parabolic curves, like the V-shaped cut-out B3, may actually grip the tree or pole more firmly, as the weight of the ladder user causes the tree to become more securely pressed into the decreasing curvature. Also, aside from the flat gripper plate, one skilled in the art could envision trusses, boxes, or other structures, other than flat plates, which might support a concave shape capable of engaging with a tree or pole.

Additionally, as depicted in FIG. 3A, a rubber friction-producing boot 3_{A} might be attached to the gripper plate B to provide friction with the tree or pole. A rubber friction-producing boot may be fabricated as an integral part of the gripper hardware for any application, or it might be used as an add-on component specifically when a ladder is leaned against a metal pole or other surface not conducive to gripping by teeth or knife-edges.

Referring back to FIG. 2, a gripper plate B or other gripper hardware may be equipped with slots B₁ through which threaded knobs or fasteners might pass, to allow the gripper to be fixed at varying positions with respect to the ladder; for example, if the ladder user prefers to be closer to, or farther from, the surface against which the ladder leans. A set of holes B₂ may be provided also, to allow the use of one or more shear pins 2 to help secure the gripper plate B in position.

Referring back to FIG. 3A, a boot 3_{A} may be fabricated from rubber or other friction-producing material, such that its curvature (or other geometry) matches that of gripper plate B (e.g. B₃ of FIG. 2). As illustrated, boot 3_{A} may be molded or machined with a V-shaped cross-section to enable it to fit over the biting or gripping edge of a gripper plate B. A rubber boot like the one depicted may be used to enhance the gripping ability of a gripper plate in operation against a tree or wooden pole, or it might be used specifically to create function against harder surfaces, such as metal poles. A rubber boot may also be made an integral part of the gripper hardware, as opposed to being a add-on component. For example, although FIG. 3B depicts a U-shaped cross section of boot 3_{A} assembled over the teeth B₄ of gripper plate B, a rubber boot can be permanently molded to the curved edge of a gripper plate for use solely in conjunction with metal poles.

Referring now to FIGS. 4A and 4B, a mounting plate A is depicted. Although a gripper plate B can be fabricated to mount directly to a ladder, a mounting plate A can be attached rigidly to the ladder, and a gripper plate B then attached rigidly to the mounting plate A. In the illustrated embodiment of the present invention, mounting plate A is depicted as a flat plate of structural material with cut-out areas A₅ in optional flanges A₁, allowing the passage of a typical pair of ladder legs. (FIG. 4B illustrates an embodiment of a mounting plate A₀ without optional flanges.) The ladder leg cut-outs A₅ in flanges A₁ (of FIG. 4A) should be of such spacing and dimensions that the mounting plate A can be slipped over the legs of most commercially available ladders.

The depiction also shows that a mounting plate A may include means for fixing the mounting plate A in place, for example clearance holes A₃, through which U-bolts may pass in order to secure the mounting plate A to the uppermost step of the ladder. A mounting plate A may also include means for rigidly attaching gripping hardware, such as gripper plate B. The FIG. 4A illustration shows a pattern of drilled and reamed holes A₂ and a pattern of tapped holes A₄, which may allow a combination of shear pins 2 and threaded fasteners or threaded knobs 1, respectively, to rigidly attach a gripper plate B to a mounting plate A. One skilled in the art can readily envision a variety of other methods by which mounting hardware might attach to a ladder and to a gripping apparatus.

In addition, other features might be added to any of the above designs. For example in FIG. 4A, the illustrated embodiment of the present invention includes strap holes A₆ allowing the attachment of a safety strap 6 (see FIGS. 7A, 7B, and 7C), to provide redundant security in holding a ladder against a tree or pole. An indentation N may also be fabricated into the surface of a gripper plate B (see FIG. 2), to allow the placement of tools or other hardware. The present embodiment of angle block C, gripper plate B, or mounting plate A can also include holes through which one end of a set of strings or cords may be secured, the other ends attached to the shear pins 2 to prevent them from being dropped from the ladder.

Additionally, FIG. 5C shows that means may be provided for gripper plate B to be attached to mounting plate A in a storage position when not in use. Likewise, FIG. 5D shows gripper plate B attached to mounting plate A so that the gripper plate is stored on the opposite or lower side (i.e. tree or pole side) of the ladder L. One skilled in the art of mechanical design can envision a variety of storage assemblies enabling the normal use of the ladder against flat surfaces while gripper plate B is not in use. The safety advantages to gripper plate storage out of the way of possible interference with the user's foot access to ladder rungs is clearly understood to the user of a ladder.

Referring to FIG. 5A, an angled bevel C₁ with tapped holes C₂ allows the attachment of angle block C to which gripper plate B can be mounted in a position flat against the ladder. In the illustrated embodiment (see FIGS. 5A, 5C and 5D), a 15-degree bevel may be used in order to accommodate the typical angle of most ladder steps. When mounting plate A is rigidly attached to the flat side of a typical ladder step, it typically will be oriented at an angle of about 15 degrees off the perpendicular to the ladder's length. An approximately 15-degree bevel on mounting plate A allows a gripper plate B to attach at the correct angle to facilitate flat storage attachment against the ladder. Referring back to FIG. 4B, a bevel A₅ may be cut directly into mounting plate A₀ (or A) to allow attachment of a gripper plate B in storage position. Alternatively, angle block C may be attached to mounting plate A or A₀, and gripper plate B attached to angle block C.

Referring again to FIG. 5A, one embodiment of angle block C is depicted. Angle block C fabricated for use in the illustrated embodiment of the present invention may be made from appropriate structural materials, and sized to essentially span the width of mounting plate A. Angle block C may contain clearance holes C₃ through which fasteners, such as cap screws, may rigidly attach angle block C to mounting plate A. Those practiced in the art may envision other embodiments, such as mounting plate A machined such that angle block C is an integral part of mounting plate A, or an embodiment in which angle block C is welded to mounting plate A. Regardless of its method of attachment, angle block C provides a surface (see bevel C₁) upon which gripper plate B, or other hardware, may be attached. In the illustrated embodiment of FIG. 5A, angle block C has a beveled edge which provides a surface (bevel C₁) parallel to the ladder length, so that hardware such as gripper plate B may be rigidly attached in a storage position parallel to the ladder, e.g. flat against the ladder (see FIG. 5A). The illustration of FIG. 5A depicts a 15-degree bevel C₁ which corresponds to the angle formed by the steps of essentially most commercially available ladders, in relation to a line perpendicular to the ladder length. Tapped holes C₂ in angle block C can correspond to a similar hole pattern in gripper plate B, such that gripper plate B may be attached to the angle block C, for example for convenient storage.

Referring to FIG. 6, one embodiment of a U-bolt clamp D is depicted, which may assist in enabling the rigid attachment of mounting plate A to a ladder. In the embodiment illustrated in FIG. 1, a set of wing nuts 4 tighten against a corresponding set of U-bolt clamps D to enable a set of U-bolts 3 to rigidly attach a mounting plate A to the uppermost step S of a ladder. The set of U-bolts 3 may comprise as few as one U-bolt, although at least two would be preferable. The illustration of FIG. 6 depicts a U-bolt clamp D of sufficient dimension to span the width of a U-bolt 3, having a hole pattern D₁ matching the dimensions of the threaded ends of the U-bolt 3. A U-bolt clamp D should be of sufficient thickness, and fabricated from appropriate material, to serve in essentially the same function as a washer, providing a hard surface against which a wing nut 4 or other nut might tighten, and protecting any mounting plate A or other hardware underneath the U-bolt clamp D from wear or deformation. In other embodiments, one might substitute other hardware, such as flat washers, for U-bolt clamps.

Referring now to FIGS. 7A, 7B, and 7C, procedures are depicted for assembling the present invention for use with a ladder, and top views are illustrated for three configurations of the assembly. In FIG. 7A, the present invention is shown securing a ladder against a tree T. FIG. 7B depicts its use against a wooden pole W. FIG. 7C shows the present invention used against a metal pole M, with the rubber boot 3_{A} in place to provide a frictional engagement between gripper plate B and the pole M. In all three configurations, a safety strap 6 is in place to reinforce secure attachment to the tree or pole. The top views also illustrate the relationship between the slots B₁ and threaded knobs 1, and shear pin holes A₂, as they may be coordinated to set a ladder in its position with respect to a tree or pole.

When assembled as described in this specification, the present invention provides a means for safely securing a ladder supported by a tree, a post, a pole, or other non-flat surface. As soon as the ladder is leaned against the tree, engaging the gripper plate with the surface of the tree, the present invention becomes functionally effective. As the operator of the ladder climbs upwardly, the gripper plate becomes even more securely engaged, due to the force applied by the operator's weight. The subject invention is simple in assembly, structurally sound, and has no moving parts, thereby minimizing possible modes of failure or malfunction. Further to the structural integrity and functional stability of the present invention, the security provided by the apparatus is redundantly ensured when the operator tightens the safety strap around the tree. The present invention therefore provides the means to use a ladder in an otherwise precarious circumstance (i.e. without a firm, flat surface against which to lean the ladder). Additionally, the design allows the gripper plate to be removed conveniently when not required, and stored flatly against the ladder while the ladder is used in more inherently stable applications against typical flat surfaces.

In conclusion, the descriptions of the present invention represent the invention in its preferred embodiment. It should be clearly understood that additional changes in the details, materials, assembly procedure, and arrangement of parts may be made by those skilled in the art within the principle and scope of the invention as expressed in the appended claims.

Although the invention has been described relative to a specific embodiment, there are numerous variations that will be readily apparent to those skilled in the art in light of the above teachings. It is therefore to be understood that, within the scope of the appended claims, the invention may be practiced other than as specifically described.

The invention claimed is:

1. A ladder stabilization apparatus, comprising:
Gripping means for gripping a non-flat surface, and
Attachment means configured for attaching the gripping means to a ladder,
the ladder stabilization apparatus having no moving parts during operation.

2. A ladder stabilization apparatus according to claim 1, wherein the gripping means for gripping a non-flat surface comprises a concave shape for engaging a non-flat surface.

3. A ladder stabilization apparatus according to claim 2, wherein the concave shape for engaging a non-flat surface comprises a plurality of teeth.

4. A ladder stabilization apparatus according to claim 2, wherein the concave shape for engaging a non-flat surface comprises a knife-edge.

5. A ladder stabilization apparatus according to claim 2, wherein the concave shape for engaging a non-flat surface comprises a friction-producing boot.

6. A ladder stabilization apparatus according to claim 2, wherein the concave shape for engaging a non-flat surface comprises a concave substantially V-shaped geometry.

7. A ladder stabilization apparatus according to claim 2, wherein the concave shape for engaging a non-flat surface comprises a concave substantially circular geometry.

8. A ladder stabilization apparatus according to claim 2, wherein the concave shape for engaging a non-flat surface comprises a concave substantially elliptical geometry.

9. A ladder stabilization apparatus according to claim 2, wherein the concave shape for engaging a non-flat surface comprises a concave substantially parabolic geometry.

10. A ladder stabilization apparatus according to claim 2, wherein the attachment means is configured to attach the gripping means to a rung of a ladder.

11. A ladder stabilization apparatus according to claim 2, wherein the attachment means comprises a set of flanges configured for enclosure of the legs of a ladder.

12. A ladder stabilization apparatus according to claim 10, wherein the attachment means comprises a set of U-bolts and associated nuts.

13. A ladder stabilization apparatus according to claim 10, wherein the attachment means comprises a set of flanges configured for enclosure of the legs of a ladder.

14. A ladder stabilization apparatus according to claim 2, wherein the gripping means for gripping a non-flat surface comprises a gripper plate.

15. A ladder stabilization apparatus according to claim 14, wherein the gripper plate comprises a plurality of teeth.

16. A ladder stabilization apparatus according to claim 14, wherein the gripper plate comprises a knife-edge.

17. A ladder stabilization apparatus according to claim 14, wherein the gripper plate comprises a friction-producing boot.

18. A ladder stabilization apparatus according to claim 14, wherein the gripper plate comprises a concave substantially V-shaped geometry.

19. A ladder stabilization apparatus according to claim 14, wherein the gripper plate comprises a concave substantially circular geometry.

20. A ladder stabilization apparatus according to claim 14, wherein the gripper plate comprises a concave substantially elliptical geometry.

21. A ladder stabilization apparatus according to claim 14, wherein the gripper plate comprises a concave substantially parabolic geometry.

22. A ladder stabilization apparatus according to claim 14, wherein the gripper plate comprises slots for slidable assembly and fore and aft position adjustment with respect to the ladder.

23. A ladder stabilization apparatus according to claim 14, wherein the attachment means comprises a mounting plate.

24. A ladder stabilization apparatus according to claim 23, wherein the mounting plate is configured for mechanical attachment to a rung of a ladder.

25. A ladder stabilization apparatus according to claim 24, wherein the gripper plate is configured for mechanical attachment to the mounting plate.

26. A ladder stabilization apparatus according to claim 25, wherein the gripper plate is adjustably positioned with respect to the mounting plate.

27. A ladder stabilization apparatus according to claim 26, wherein the mounting plate comprises a set of flanges for attachment to the legs of a ladder.

28. A ladder stabilization apparatus according to claim 25, further comprising storage means for storing the gripper plate.

29. A ladder stabilization apparatus according to claim 28, wherein the storage means comprises an angle block.

30. A ladder stabilization apparatus according to claim 29, wherein the angle block is configured to allow attachment of the gripper plate in a storage position substantially flat against a ladder.
